(19) United States
(12) Patent Application Publication
(10) Pub. No.: US 2012/0317254 A1
(43) Pub. Date: Dec. 13, 2012

(54) NETWORK PLATFORM IN A NETWORK DEVICE ECOSYSTEM

(76) Inventors: Mark CHEKHANOVSKIY, San Jose, CA (US); Aaron Hyman AVERBUCH, Seattle, WA (US); Siddhartha DATTAGUPTA, Irvine, CA (US); Craig A. HOBBS, Seattle, WA (US); Matthew TEBBS, Seattle, WA (US); John-Anthony OWENS, Seattle, WA (US)

(21) Appl. No.: 13/156,187

(22) Filed: Jun. 8, 2011

(51) Int. Cl. G06F 15/177

(52) U.S. Cl. 709/222

(57) ABSTRACT

A smart network may include a smart network host device as well as one or more client devices configured to connect to the smart network. Each of the client devices may implement one or more services that the client device exposes to other devices connected to the smart network. When a client device connects to the smart network, the client device may transmit a message to the smart network host device requesting the client device and zero or more services to be registered on the smart network. Once the client device and services are registered, other devices on the smart network may identify and utilize the resources or functions provided by the client device by querying the smart network host device for information related to the resources on the smart network. The smart network host device also notifies services about relevant service events on the smart network.

### BACKGROUND

1. Technical Field

The present disclosure relates generally to wireless networks and, more specifically, to a network platform in a network device ecosystem.

2. Description of the Related Art

Home networks, in which multiple computing and/or peripheral devices are communicatively linked together in a consumer's home, are becoming increasingly ubiquitous. A home environment may include one or more computers, a wireless router, a dsl modem, and one or more other devices capable of connecting to the home network. Conventionally, each device in the home network must be individually configured to connect to the network and, once configured, may then communicate with each of the other devices attached to the home network.

In practice, however, procedures for establishing and provisioning services on a home network are typically too involved for the majority of home network users to implement reliably. For example, a network user may need to manually reconfigure the home network router, determine a network IP address and/or hostname for each device, establish network credentials, register the various services for each device, etc. Furthermore, in order for a device to locate another device on the home network, a device must establish communication using a unique IP address of the other device. Such connections are typically defined as peer-to-peer connections. A user may be required to manually keep track of which address is associated with which device or service in order to configure the devices to communicate on the home network. The manual configuration procedures described above make it a challenge for unsophisticated users to reliably setup a home network and provision services on the home network.

Accordingly, there is a need in the art for systems and methods that reliably and conveniently enable the user of a home network to automatically configure and provision services provided by one or more client devices on the home network.

### BRIEF DESCRIPTION OF THE DRAWINGS

So that the manner in which the features of the present disclosure can be understood in detail, a more particular description may be had by reference to example embodiments, some of which are illustrated in the appended drawings. It is to be noted, however, that the appended drawings illustrate only example embodiments of this invention and are therefore not to be considered limiting of its scope, for the disclosure may admit to other equally effective embodiments.

FIG. 1A is an exemplary illustration of an overarching network system configured to implement one or more aspects of the present invention;

FIG. 1B illustrates the smart home network of FIG. 1A, according to one example embodiment of the present invention;

FIG. 1C illustrates the smart home network of FIG. 1A, according to another example embodiment of the present invention;

FIG. 1D illustrates the smart home network of FIG. 1A, according to yet another example embodiment of the present invention;

FIG. 1E is a more detailed illustration of the smart network host device of FIG. 1A, according to one example embodiment of the present invention;

FIG. 1F illustrates a system software architecture for the smart network host device of FIG. 1E, according to one example embodiment of the present invention;

FIG. 2 illustrates a system for provisioning devices and services on the smart network, according to one example embodiment of the present invention;

FIG. 3 illustrates a database for provisioning client devices and services on the smart network, according to one example embodiment of the present invention;

FIG. 4 is a conceptual diagram that illustrates the registration of client devices and services on the smart network, according to one example embodiment of the present invention;

FIG. 5 is a conceptual diagram that illustrates a mechanism for exposing service events to services on the smart network, according to one example embodiment of the present invention;

FIG. 6 is a flowchart of method steps for registering services with a smart network host device and exposing available services to a client device, according to one example embodiment of the present invention; and

FIG. 7 is a flowchart of method steps for registering services with an event hub server implemented by a smart network host device, according to one example embodiment of the present invention.

For clarity, identical reference numbers have been used, where applicable, to designate identical elements that are common between figures. It is contemplated that features of one example embodiment may be incorporated in other example embodiments without further recitation.

### DESCRIPTION OF EXAMPLE EMBODIMENTS

In the following description, numerous specific details are set forth to provide a more thorough understanding of various example embodiments of the invention. However, it will be apparent to one of skill in the art that certain embodiments of the invention may be practiced without one or more of these specific details. In other instances, well-known features have not been described in order to avoid obscuring the invention.

### Overview

One example embodiment of the present invention sets forth a method comprising receiving a first message requesting that a first client device be registered with a central authority associated with a local network, where the first client device is identified by a first internet protocol (IP) address and implements one or more services, and each instance of a particular service is accessible at a different port of a network interface associated with the first client device. The method further includes the steps of, in response to the first message, assigning a first domain name to the first client device and adding a first entry to a database that relates the first domain name to the first IP address, and for each instance of the particular service implemented on the first client device, adding a corresponding entry in the database that relates the instance to one of the different ports as well as the first domain name. The method also includes the steps of transmitting a response message to the first client device that indicates the first domain name assigned to the first client device.

Another example embodiment of the present invention sets forth a system comprising a first client device, wherein the first client device is identified by a first internet protocol (IP) address and implements one or more services, and each instance of a particular service is accessible at a different port of a network interface associated with the first client device, and a smart network host device configured to receive a first message requesting that the first client device be registered with a central authority associated with a local network. The smart network host device is further configured to, in response to the first message, assign a first domain name to the first client device and add a first entry to a database that relates the first domain name to the first IP address, and for each instance of the particular service implemented on the first client device, add a corresponding entry in the database that relates the instance to one of the different ports as well as the first domain name. The smart network host device is further configured to transmit a response message to the first client device that indicates the first domain name assigned to the first client device.

Yet another example embodiment of the present invention sets forth a computer-readable medium including instructions that, when executed by a processing unit, cause the processing unit to perform the steps of receiving a first message requesting that a first client device be registered with a central authority associated with a local network, where the first client device is identified by a first internet protocol (IP) address and implements one or more services, and each instance of a particular service is accessible at a different port of a network interface associated with the first client device. The steps further comprising, in response to the first message, assigning a first domain name to the first client device and adding a first entry to a database that relates the first domain name to the first IP address, and for each instance of the particular service implemented on the first client device, adding a corresponding entry in the database that relates the instance to one of the different ports as well as the first domain name. The steps further comprising transmitting a response message to the first client device that indicates the first domain name assigned to the first client device.

### DETAILED DESCRIPTION OF THE FIGURES

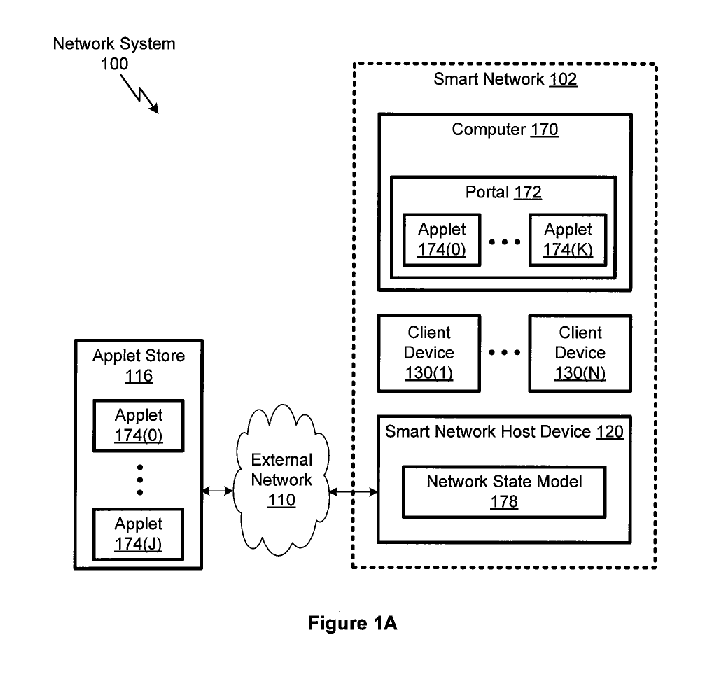

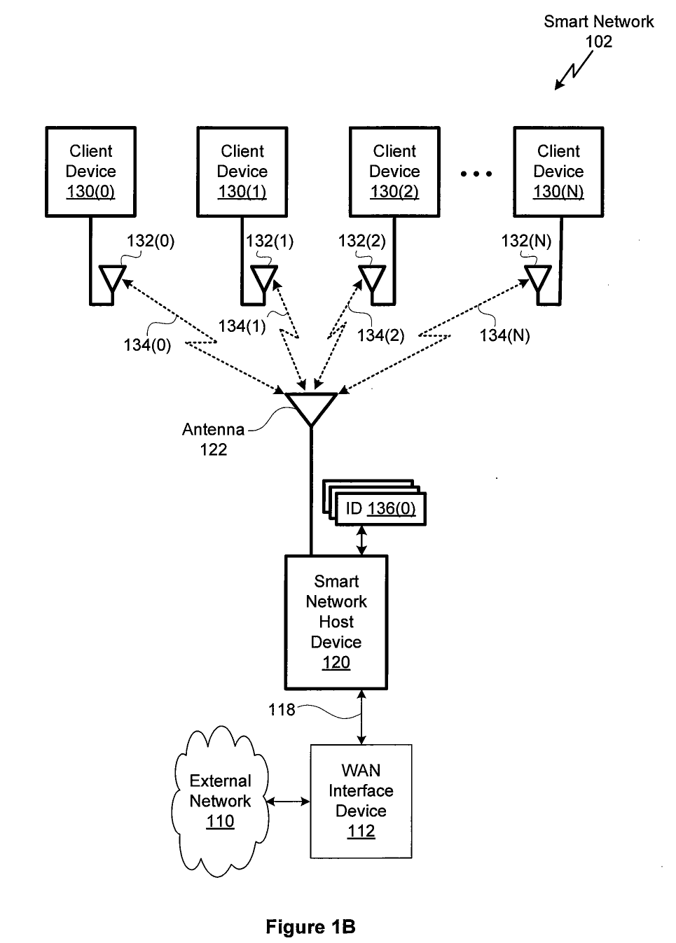

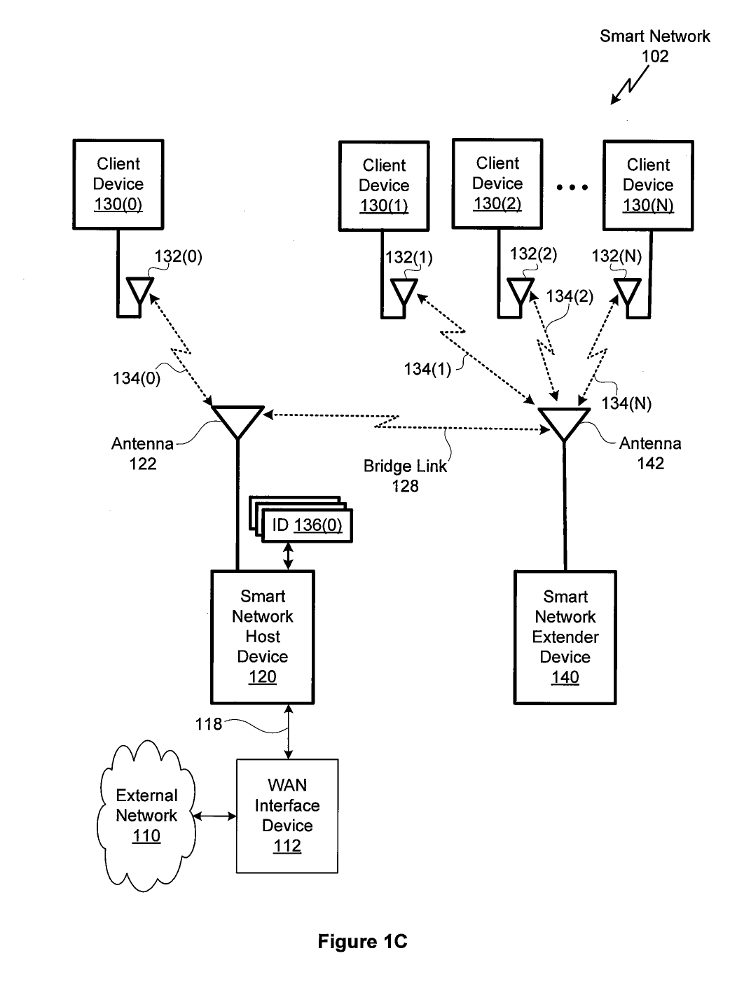

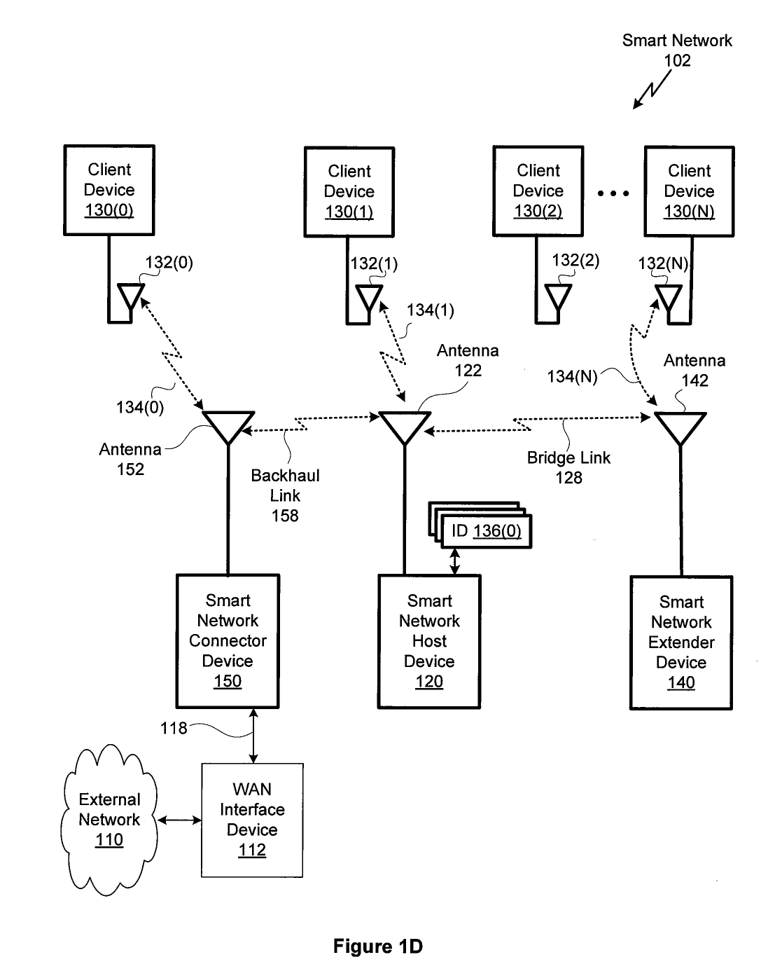

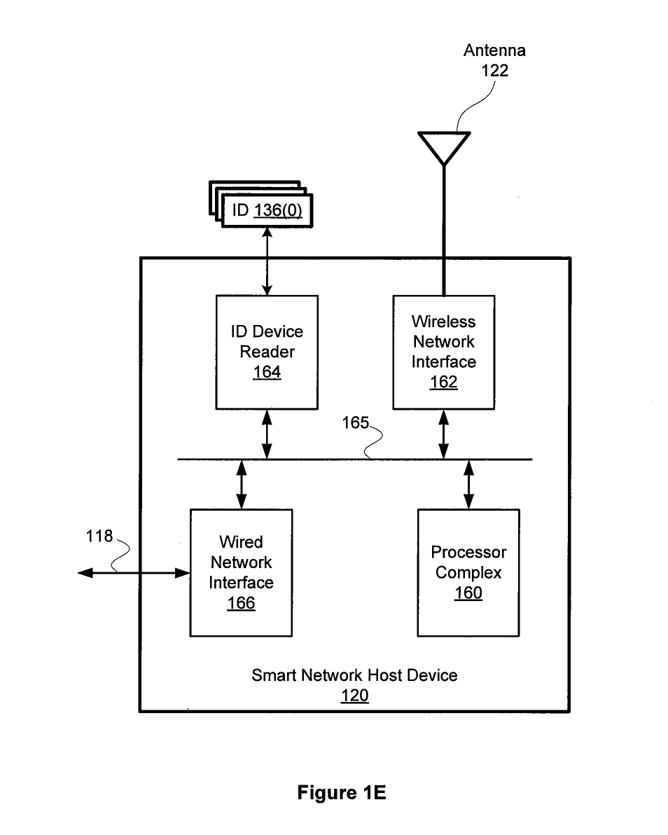

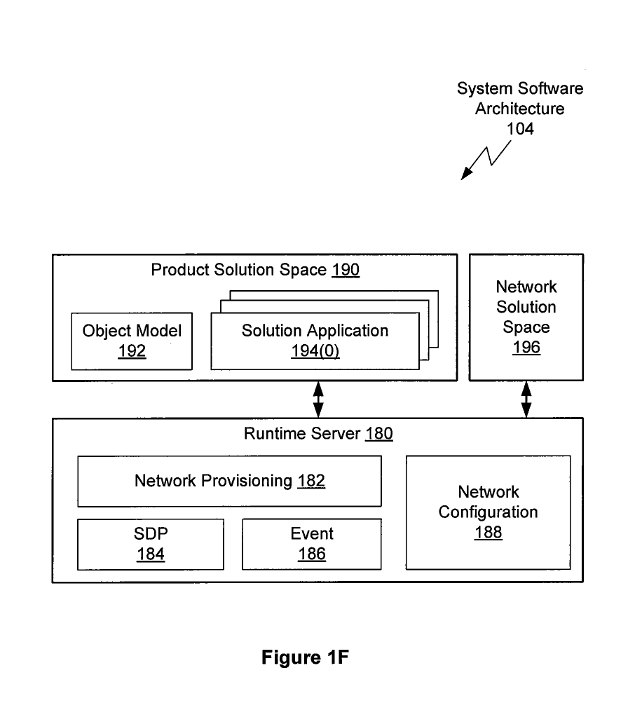

FIG. 1A is an exemplary illustration of an overarching network system 100 configured to implement one or more aspects of the present invention. The network system 100 comprises a smart network 102, an external network 110, and an applet store 116. The external network 110 may comprise the well-known Internet or any other data network system. The smart network 102 includes a smart network host device 120 configured to transmit network data packets between the external network 110 and connected devices within the smart network 102, such as computer 170 and client devices 130. Any technically feasible wireless or wired physical transport technology may be implemented to transmit the network data packets. The smart network host device 120 maintains a network state model 178 that represents the different entities and related services operating within the smart network 102. For example, if client device 130(0) implements a printer with an integrated scanner and flash memory reader, then the network state model 178 would include an entry for client device 130(0), and related attributes for a printer service, scanner service, and file (or block device) service. New devices register with the smart network host device 120, which then updates the network state model 178 to include the new device.

A portal application 172, residing within the computer 170, is configured to access the network state model 178 to determine which client devices 130 are available within the smart network 102, which services the client devices 130 provide, and to access and use the services. The portal application 172 may include one or more applets 174, configured to extend functionality of the portal application 172. A given applet 174 may be associated with a specific client device 130 and may facilitate specific usage models for the client device 130 via the extended functionality. When a new client device 130 registers with the smart network 102, a most recent version of a corresponding applet 174 may not be available within the portal application 172. However, the portal application 172 may retrieve the corresponding applet 174 or version of the corresponding applet 174 from the applet store 116.

The applet store 116 is configured to facilitate access to applets 174 by the portal application 172. The applet store 116 provides storage for applets 174 corresponding to client devices 130 and makes the applets 174 available for download to the portal application 172 via the external network 110. In one embodiment, the applet store 116 occupies a well-known location, such as a universal resource locator (URL) associated with the external network 110. Any technically feasible technique may be used to identify a particular applet 174 as corresponding to a particular client device 130. Furthermore, any technically feasible technique may be used to download the particular applet 174 an incorporate the functionality of the applet 174 to the portal 172.

FIG. 1B illustrates the smart home network 102 of FIG. 1A, according to one example embodiment of the present invention. As shown, the smart network 102 comprises a smart network host device 120, one or more client devices 130, and a wide area network (WAN) interface device 112, coupled to the external network 110 of FIG. 1A. The WAN interface device 112 may implement a cable modem, digital subscriber line (DSL) modem, fiber to the home interface, or any other technically feasible device that provides digital network connectivity to the external network 110. The WAN interface device 112 is coupled to the smart network host device 120 via a network interface 118. In one embodiment, the network interface 118 implements the well-known Ethernet standard.

The smart network host device 120 implements a wireless network interface coupled to antenna 122, which is configured to convert electrical signals to electromagnetic signals for transmitting data packets, and electromagnetic signals to electrical signals for receiving data packets. The antenna 122 may comprise plural independent radiator structures, each having a separate radiation pattern for implementing spatial multiplexing. In one embodiment, the wireless network interface implements one or more well-known standards, such as the Institute of Electrical and Electronics Engineers (IEEE) standard 802.11, which defines a system for wireless local area networking. The antenna 122 is configured establish wireless client links 134 to antennas 132 coupled to corresponding client devices 130. The smart network host device 120 implements Ethernet layer 2 switching for wireless data packets forwarded among client devices 130 as well as internet protocol (IP) layer 3 routing between an IP domain associated with the smart network 102 and the external network 110. In this configuration, the smart network host device 120 provides related services and protocols, such as dynamic host configuration protocol (DHCP), network address translation (NAT), and the like.

The smart network host device 120 acts as a central authentication authority for the smart network 102 and implements authentication services for devices registering with the smart network 102. In one embodiment, authentication is implemented via Identification (ID) devices 136 that are uniquely paired with corresponding client devices 130. For example, client device 130(0) may be uniquely paired with ID device 136(0) by a manufacturer of the client device 130(0). An ID device 136(0) is physically presented to the smart network host device 120 as an authentication credential to allow a client device 130(0) paired to the ID device 136(0) to join the smart network 102. Furthermore, the client device 130(0) is able to authenticate the smart network 102 as a trusted network by accessing credentials for the corresponding ID device 136(0) specifically via the smart network 102. In one embodiment, the ID devices 136 are implemented as near field radio frequency identification (RFID) tags. Each one of the RFID tags is configured to retain authentication credentials necessary to uniquely associate the one RFID tag with one instance of the client device 130. In this way, an RFID tag may be paired with a given client device 130. Persons skilled in the art will recognize that any technique may be implemented to generate and represent authentication credentials without departing the scope and spirit of the present disclosure. For example, in another embodiment, the ID devices 136 could be implemented as a physical token that includes a printed bar code on a face of the token. The bar code may encode authentication credentials for a corresponding client device 130. In such an embodiment, the smart network host device 120 may include an optical scanner capable of reading the printed bar code from the physical token. In alternative embodiments, other forms of ID devices 136 may implement storage of the authentication credentials. For example, a universal serial bus (USB) storage device may be used to present authentication credentials to the smart network host device 120 for authenticating a related device, such as the computer 170. In other alternative embodiments, a user may manually authenticate a client device 130 with the smart network host device 120. For example, the user may log onto a management web page generated by the smart network host device 120 and manually enter authentication credentials, such as a printed code associated with the client device 130. In yet other embodiments, the smart network host device 120 and one or more client devices 130 may implement the Wi-Fi Protected Setup (WPS) protocol for establishing and securing the smart network 102.

In one usage scenario involving ID device 136, the user wishes to add a new device, such as a smart network-enabled printer to the smart network 102. The printer includes an ID device 136 implemented as an RFID tag that is paired to the printer. The user places the ID device 136 in close physical proximity to the smart network host device 120, which is the able to read the ID device 136 and authenticate the printer. The printer registers with the smart network host device 120 and is then available for use by devices connected within the smart network 102. Upon successfully reading the ID device 136, the smart network host device 120 may indicate success to the user by flashing a light-emitting diode (LED), or by generating any technically feasible indication.

FIG. 1C illustrates the smart home network 102 of FIG. 1A, according to another example embodiment of the present invention. Here, the smart network 102 comprises a smart network host device 120, a smart network extender device 140, one or more client devices 130, and a wide area network (WAN) interface device 112, coupled to the external network 110 of FIG. 1A. The WAN interface device 112, smart network host device 120, and one or more client devices 130 are configured to operate as previously described in FIG. 1B.

In addition to previously described functionality, the smart network host device 120 is also configured to detect one or more smart network extender devices 140 and to establish a bridge link 128 to each of the one or more smart network extender devices 140. Each smart network extender device 140 is configured to act as a network bridge between a client device 130 and the smart network host device 120. For example, client devices 130(1) through 130(N) may be physically located such that they are able to connect to the smart network extender device 140, but not to the smart network host device 120. Furthermore, the smart network extender device 140 is able to connect to the smart network host device 120 via bridge link 128. Data packets transmitted by client devices 130(1) through 130(N) and destined to the external network 110 are received by the smart network extender device 140 and retransmitted by the smart network extender device 140 via bridge link 128 to the smart network host device 120, which then forwards the data packets to the external network 110. Similarly, data packets from the external network 110 that are destined to any of the client devices 130(1) through 130(N) are transmitted via bridge link 128 to the smart network extender device 140, which retransmits the data packets via wireless client links 134(1)-134(N). Persons skilled in the art will understand that wireless client links 134(1)-134(N) may each be configured to operate on a separate channel or band, or a common channel or band. Furthermore, bridge link 128 may operate on a separate channel or band with respect to the wireless client links 134.

In one embodiment, each smart network extender device 140 is paired to an ID device 136, which is presented as an authentication credential to the smart network host device 120 to enable the smart network extender device 140 to participate within the smart network 102.

FIG. 1D illustrates the smart home network 102 of FIG. 1A, according to yet another example embodiment of the present invention. Here, the smart network 102 comprises a smart network host device 120, a smart network extender device 140, one or more client devices 130, a smart network connector device 150, and a wide area network (WAN) interface device 112, coupled to the external network 110 of FIG. 1A. The WAN interface device 112, smart network extender device 140, and one or more client devices 130 are configured to operate as previously described in FIGS. 1B and 1C.

In this embodiment, the smart network host device 120 is configured to operate similarly with respect to FIGS. 1B and 1C. However, upon detecting the smart network connector device 150, the smart network host device 120 is configured to operate as a bridge rather than a router, and the smart network connector device 150 is configured to operate as a router. A backhaul link 158 is established between the smart network host device 120 and the smart network connector device 150.

Network data traffic between client device 130(N) and the external network 110 traverses wireless client link 134(N), bridge link 128, and backhaul link 158. This network data traffic is also forwarded by smart network extender device 140, smart network host device 120, and smart network connector device 150. A client device 130 may connect directly to any one of the network extender device 140, smart network host device 120, or smart network connector device 150. As shown, client device 130(0) is connected to smart network connector device 150 via wireless client link 134(0), client device 130(1) is connected to smart network host device 120 via wireless client link 134(1), and client device 130(N) is connected to smart network extender device 140 via wireless client link 134(N).

In one embodiment, the smart network connector device 150 is paired to an ID device 136, which is presented as an authentication credential to the smart network host device 120 to enable the smart network connector device 150 to participate within the smart network 102. In an alternative embodiment, the smart network connector device 150 and the smart network host device 120 are paired during a manufacturing step, eliminating the need for a separate ID device 136.

FIG. 1E is a more detailed illustration of the smart network host device 120 of FIG. 1A, according to one example embodiment of the present invention. As shown, the smart network host device 120 comprises a processor complex, 160, a wireless network interface 162, an ID device reader 164, and a wired network interface 166. An interconnect 165 is configured to transmit data among the processor complex 160, wireless network interface 162, ID device reader 164, and wired network interface 166. The wired network interface 166 is configured transmit data packets via network interface 118, based on data received via the interconnect 165. The wired network interface 166 is also configured to receive data packets from the network interface 118 and transmit contents of the received data packets to the processor complex 160 via the interconnect 165. The wireless network interface 162 is configured to transmit data packets, based on data received via the interconnect 165, to one or more network devices within range. The wireless network interface 162 is also configured to receive data packets from the one or more network devices and then transmit contents of the received packets to the processor complex 160. The wireless network interface 162 is coupled to an antenna 122.

The processor complex 160 comprises a central processing unit (CPU), non-volatile memory for storing persistent programs, program state, and configuration information, random access memory (RAM) for storing temporary or volatile data, and an interface to the interconnect 165. In one embodiment, the processor complex 160 is configured to execute an operating system and applications that provide routing services. The routing services may include, for example, data packet forwarding between the network interface 118 and the wireless network interface 162. The packet forwarding services may include, without limitation, bridging among the one or more network devices via the wireless network interface 162.

The ID device reader 164 is configured to read data from an associated ID device 136. In one embodiment, the ID device reader 164 is configured to read data from RFID tags comprising the ID device 136. The ID device reader 164 may also include a USB reader. In another embodiment, the ID device reader 164 may be implemented as an optical scanner for reading ID devices 136 that encode data via a printed bar code. In yet other embodiments, the ID device reader 164 may be configured to read data from other types of interfaces, such as other types of flash memories like an SD flash card.

In certain embodiments, the smart network host device 120 comprises one or more integrated circuits that implement respective functions of the smart network host device 120. For example, the processor complex 160, wired network interface 166, and wireless network interface 162 may be integrated into a single integrated circuit.

Persons skilled in the art will recognize that the smart network extender device 140 may be implemented using the basic architecture of the smart network host device 120, with the exception that the ID device reader 164 and wired network interface 166 are not required for the smart network extender device 140. Similarly, the smart network connector device 150 may be implemented using the basic architecture of the smart network host device 120, with the exception that the ID device reader 164 is not required for the smart network connector device 150.

FIG. 1F illustrates a system software architecture for the smart network host device of FIG. 1E, according to one example embodiment of the present invention. As shown, the software architecture 104 includes several software modules within the smart network host device 120. Programming instructions stored within the processor complex 160 implement a portion of the system software architecture 104 that includes a runtime server 180, a product solution space 190, and a network solution space 196. The product solution space 190 comprises an object model 192 and one or more solution applications 194. The object model 192 provides a standard, consistent abstraction of different network elements and related services within the smart network 102. Exemplary network elements include devices coupled to the smart network 102, such as printers, cameras, and display devices. Exemplary services include device and service discovery, event tracking and generation, and state presentation for the different elements. In one embodiment, the object model 192 includes a network interface based on the well-known extensible markup language (XML). One or more solution applications 194 provide specific functionality, such as a specific view of a storage system, or a specific technique for presenting certain data. The network solution space 196 includes software modules configured to provide management of network elements and network services, including device services, local area network services within the smart network 102, and wide area network services related to connectivity management of the external network 110.

The runtime server 180 comprises a network provisioning module 182, a service and discovery provisioning (SDP) module 184, an event module 186, and a network configuration module 188. The event module 186 tracks different network events, such as a network device advertising presence or updating status within the smart network 102. The SDP module 184 maintains a persistent view of different network devices and related services, based on data from the event module 186 and on data from the network devices. The network provisioning module 182 provides authentication and authorization for network devices within the smart network 102. Authentication credentials may be presented via a given ID device 136. The network provisioning module 182 may also facilitate certain network services, such as DHCP leases. The network configuration module 188 includes hardware platform-specific implementation methods for network configuration and management. The persistent view comprises the network state model 178 of FIG. 1A.

Persons skilled in the art will recognize that the smart network connector device 150 and smart network extender device 140 may be implemented using an appropriate subset of the system software architecture 104 described above in conjunction with FIG. 1F.

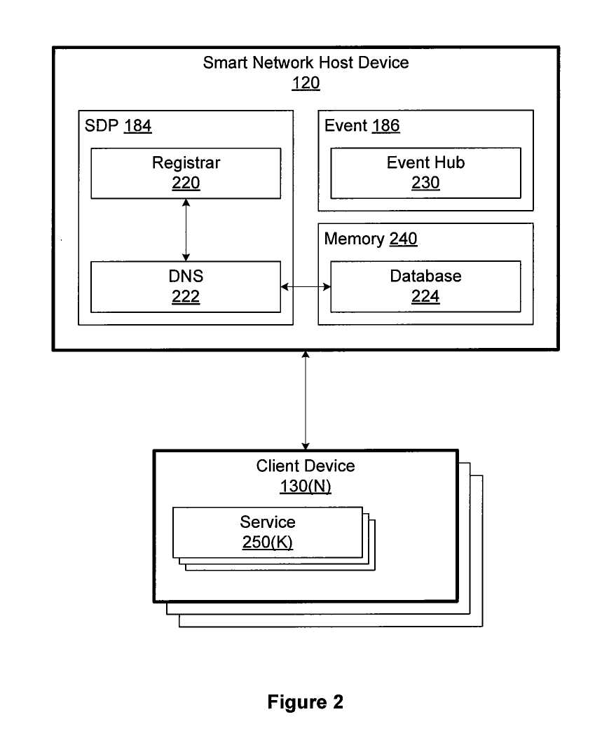

FIG. 2 illustrates a system for provisioning devices and services on the smart network 102, according to one example embodiment of the present invention. As shown in FIG. 2, one or more client devices 130 may be connected to the smart network 102. Each client device 130(0)-130(N) may implement one or more services 250(0)-250(K) that are registered with the smart network host device 120 and made available to one or more other client devices 130 connected to the smart network 102. In one embodiment, the services 250 registered on the smart network 102 may be made available to one or more remote devices (not shown) connected to the smart network 102 via the external network 110.

In one embodiment, a service 250 implements inter-process communications by transmitting XML messages via a network interface of a host device that implements the service 250. A service 250 is defined as a set of zero or more SOAP actions and zero or more service events and may be implemented as a set of software instructions that are executed on one or more processors included in the host device. For example, the smart network host device 120 may implement a service 250 as a set of instructions configured to be executed by the processor complex 160.

A service 250 may be configured to send or receive XML messages via a network interface of the host device in order to communicate with other client devices 130 or services 250 connected to the smart network 102. The service 250 may be accessible through a port of a network interface implemented on the host device. Each port may be associated with a single instance of a service 250, and multiple instances of a service 250 may be accessible through different ports of the host device. Each service 250 may include a version number that identifies the particular set of operations defined by the service, which may be used to detect and prompt for updates to be downloaded to the host device by querying the smart network or a portal located on the external network 110.

As also shown in FIG. 2, the smart network host device 120 includes an SDP module 184, an event module 186, and a memory 240. As described above in connection with FIG. 1F, the SDP module 184 maintains a persistent view of different network devices and related services, based on data from the event module 186 and on data from the different client devices 130. In one embodiment, the SDP module 184 includes a registrar server 220 and a domain name system (DNS) server 222. The registrar server 220 implements an application programming interface (API) that enables a client device 130 to register with the smart network host device 120 and discover other client devices 130 and services 250 connected to the smart network 102. The DNS server 222 implements an API for adding, updating, or deleting entries in a database 224 stored in the memory 240. The DNS server 222 may be a standard domain name system server. In alternative embodiments, the DNS server 222 may be replaced by a different type of server that implements a custom set of functions to add, update, or delete entries in the database 224. In such alternative embodiments, each entry in the database 224 may be a data structure or a pointer to a data structure that stores information about a client device 130 or server 250. For example, database 224 may be configured as a hash table associated with a hash function that receives a domain name associated with a client device 130 or service 250 and returns a key into the hash table based on the domain name. The entries in the hash table may be pointers to one or more data structures stored in memory 240 that include information about a particular client device 130 or service 250 connected to the smart network 102.

The event module 186 includes an event hub server 230 that implements an API for exposing service events to one or more client devices 130 or services 250. The event hub server 230 manages one or more lists of client devices 130 or services 250 that subscribe (i.e., register) to be notified when certain types of events are generated. Events are declared in service 250 definitions, and each definition may include zero or more events. Each event may be identified by a uniform resource identifier (URI) and a corresponding schema for the event payload (i.e., data including information related to the event). Calls made to the event hub server 230 include the URI associated with the event and the domain name associated with the source of the event. Once a client device 130 or service 250 has registered with the event hub server 230, the client device 130 or service 250 may receive messages whenever a different client device 130 or service 250 makes a call to the event hub server 230 that specifies an event of a type that matches the types of events that the particular client device 130 or service 250 has subscribed to. In order to receive the messages from the event hub server 230, a client device 130 may implement an EventNotify service (not shown) and register the EventNotify service with the registrar server 220. Event notifications or messages are issued from the event hub server 230 to the EventNotify service running on a particular client device 130. In one embodiment, the registrar server 220 may issue event notifications or messages based on events generated by the registrar server 220 directly from the registrar server 220 to the particular EventNotify service running on a client device 130.

For example, a first client device 130(1) may implement a service 250(1) for viewing media such as recorded television programs. When the first client device 130(1) connects to the smart network 102, the first client device 130(1) makes a call to the registrar server 220 to register the client device 130(1) and the service 250(1) with the smart network host device. The service 250(1) may make a call to the event hub server 230 in order to register to be notified whenever an event type matching a program_recording_finished type is received by the event hub server 230. A second client device 130(2) may implement a service 250(2) for recording media on a large storage disk. When the second client device 130(2) finishes recording a particular program, service 250(2) may be configured to generate a program_recording_finished event and notify the event hub server 230 of the event. The event hub server 230 determines that the first client has subscribed to be notified whenever this type of event has been generated and, therefore, sends a message to service 250(1) on the first client device 130(1) informing service 250(1) about the event generated by the second client device 130(2). In response to receiving the message about the event, the first client 130(1) may perform certain tasks based on information associated with the event. For instance, in the above example, the first client device 130(1) may update a user interface, such as a menu on a television screen, to include a listing of the recorded program in a list of available recordings.

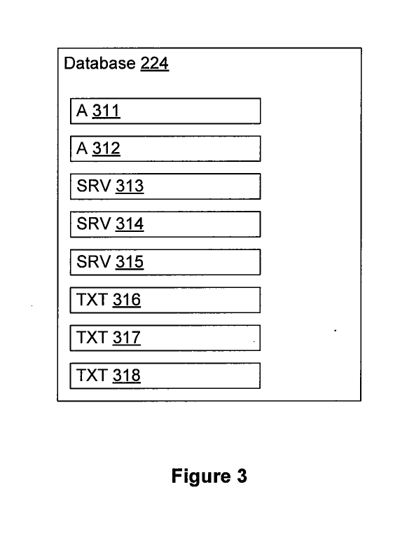

FIG. 3 illustrates a database 224 for provisioning client devices 130 and services 250 on the smart network 102, according to one example embodiment of the present invention. The database 224 includes one or more entries related to various client devices 130 and services 250 connected to the smart network 102. In one embodiment, database 224 is configured as a domain name server database that includes one or more resource records 311-318 that may be used to resolve a domain name into an IP address or provide various information related to the associated client device 130 or service 250. Each client device 130 connected to the smart network 102 registers with the smart network host device 120 by making a call to the registrar server 220 to add the client device 130 to the smart network 102. For each client device 130 added to the smart network 102, an A type resource record such as resource record 311 or resource record 312 is added to database 224. The contents of the A record may include a domain name for the client device 130 and the IP address assigned to the client device 130. An A type resource record includes information relating a domain name to an IPv4 address (32 bit). In some embodiments, each A type resource record may correspond to an AAAA type resource record that includes information relating the same domain name of the corresponding A type resource record to an IPv6 address (128 bit).

Each client device 130 may also include one or more services 250 that may be exposed to other devices on the smart network 102 or devices that connect remotely to smart network 102 via external network 110. A client device 130 may assign each instance of a service 250 running on client device 130 to a separate port of client device 130. Thus, each service 250 may be called by sending a message to the particular port assigned to the service at the IP address assigned to the client device 130 that implements the service 250. The client device 130 registers each service 250 that the client device exposes to the smart network 102 by making a call to the registrar server 220 on the smart network host device 120. When the registrar server 220 receives the message requesting that one or more services 250 be registered on the smart network 102, the registrar server 220 calls the DNS server 222 to add or update a resource record to database 224. For each instance of a service 250 registered with registrar server 220 a corresponding SRV type resource record is added to database 224. An SRV record may include information that specifies the client device that hosts the associated service 250 as well as the port assigned to that service 250.

As shown in FIG. 3, database 224 may include resource records 311 and 312 that correspond to client device 130(0) and 130(1), respectively. Resource record 311 includes information such as an IP address associated with the domain name assigned to client device 130(0). Similarly, resource record 312 includes information such as an IP address associated with the domain name assigned to client device 130(1). Database 224 also includes SRV type resource records 313, 314 and 315 corresponding to three services 250 hosted by one or more devices 130 connected to the smart network 102. For example, services 250(0) and 250(1) may be hosted on client device 130(0) and service 250(2) may be hosted on client device 130(1). Each SRV resource record may include information such as the domain name identifying the host device, as well as the port of the host device that is assigned to the service associated with that SRV resource record. Based on the above example, the SRV resource record 313 corresponds to service 250(0), the SRV resource record 314 corresponds to service 250(1), and the SRV resource record 315 corresponds to service 250(2). SRV resource records 313 and 314 may include information listing the domain name assigned to client device 130(0) while SRV resource record 315 may include information listing the domain name assigned to client device 130(1). SRV resource records 331, 314 and 315 may also include the port numbers assigned to services 250(0), 250(1) and 250(2), respectively.

In addition to A/AAAA resource records and SRV resource records that define the location of client devices 130 and services 250, respectively, in the smart network 102, database 224 may include one or more additional types of resource records. As shown in FIG. 3, a TXT type resource record may be included in database 224 that enables clients to retrieve additional information about a client device 130 or a service 250 corresponding to an A/AAAA resource record or an SRV resource record. For example, TXT resource record 316 may correspond to service 250(0) and may provide a client device 130 with version information, a friendly name, or other information related to service 250(0). Similarly, TXT resource records 317 and 318 may correspond to services 250(1) and 250(2), respectively. Other types of resource records may include an SOA resource record that indicates a source of authority in the DNS database, an NS resource record that identifies a different name server for a subdomain of the smart network 102, and a PTR resource record that identifies the domain name(s) of a host and/or service(s) located at a particular IP address (i.e., for a reverse DNS lookup). Other types of resource records may be defined and included in database 224 and are within the scope and spirit of the present disclosure.

In one embodiment, each client device 130 implements a TCP/IP network stack that includes a DNS client. The DNS client may query the DNS server 222 to discover an IP address and port for the registrar server 220 running on the smart network host device 120. Once the DNS server 222 has returned an IP address and port for the registrar server 220, the client device 130 may make a call to the registrar server 220 to register the device and any services the client device 130 makes available on the smart network 102. In alternative embodiments, each client device 130 may discover the IP address and port for the registrar server 220 via a vendor-defined DHCP option. In such alternative embodiments, the network provisioning module 182 of the smart network host device 120 may implement a DHCP server. When a client device 130 connects to the smart network 102, the client device 130 may call the DHCP server to acquire an IP address. During a final stage of IP address acquisition via the DHCP server, a client device 130 may be exposed to the location of the registrar server 220 via a DHCPACK message sent from the DHCP server to the DHCP client on the client device 130. The DHCPACK message may include the URL (i.e., domain name) for the registrar server 220 that may then be resolved using the DNS server 222 to retrieve the corresponding IP address and port for the registrar server 220 on the smart network host device 120.

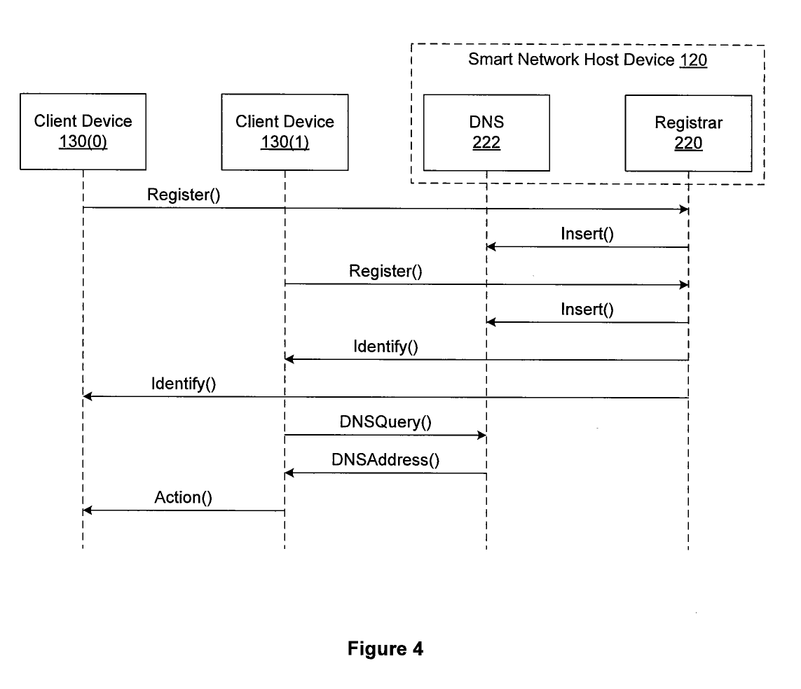

FIG. 4 is a conceptual diagram that illustrates the registration of client devices 130 and services 250 on the smart network 102, according to one example embodiment of the present invention. As shown in FIG. 4, the smart network 102 includes a smart network host device 120 as well as a first client device 130(0) and a second client device 130(1). The smart network host device 120 includes a registrar server 220 and a DNS server 222. The smart network host device 120 and the client devices 130 are configured as described above in connection with FIGS. 1A-1F, 2 and 3.

The smart network 102 includes the smart network host device 120 as an always-on central authority. As a first client device 130(0) is added to the smart network 102, such as by placing an ID device 136 in proximity of the ID device reader 164, the client device 130(0) is configured to negotiate network credentials with the smart network host device 120 and connect to the smart network host device 120 via a secure socket connection. Once the first client device 130(0) is connected to the smart network 102, an IP address may be assigned to the first client device 130(0) by calling a DHCP server on the smart network host device. The DHCP server may assign an unallocated IP address allocated to the smart network 102 to the first client device, such as 192.168.15.1. Similarly, the second client device 130(1) is added to the smart network 102 in a similar manner as that described for the first client device 130(0) and assigned a different IP address, such as 192.168.15.1. In the smart network 102, the smart network host device 120 may be configured to use a default static IP address stored in a configuration file written to a non-volatile memory during manufacture (which may be changed during initial setup of the smart network host device 102), such as 192.168.1.1. In contrast, the DHCP server may assign client devices 130 a dynamic IP address that may change each time the client devices 130 connect to the smart network 102.

Once the first client device 130(0) has obtained an IP address, the first client device 130(0) may make a call to the registrar server 220 to register the device and one or more services 250 hosted by the client device 130(0). As described above, the first client device 130(0) may retrieve a well-known domain name for the registrar server 220 via a DHCP vendor-defined DHCP option. The first client device 130(0) transmits a Register( ) message to the registrar server 220. In one embodiment, the Register( ) message may be an XML message that includes three arguments passed as inputs. The arguments may be data structures formatted as XML messages. A first argument may include information that specifies information related to a client device 130, such as the name of the manufacturer, a description of the device, a model number, a serial number, a device type, a device ID, a device status, and a friendly name, among other like information. The second argument may include information that specifies the services that the client device 130 may expose to the smart network 102, such as an enumeration of services that include information about a service type, a service ID, a friendly name, a service status, a description of the service, and a control URL, among other like information. The third argument may include information that specifies the type of devices or services that the client device 130 would like to consume, such as a list of device types or service types that may be compatible with certain protocols implemented by the client device 130, among other like information.

In response to receiving a Register( ) message from the first client device 130(0), the registrar server 220 may assign a unique domain name to the first client device 130(0) to identify the first client device 130(0) on the smart network 102. Similarly, the registrar server 220 may assign a unique domain name to each service 250 exposed to the smart network by the first client device 130(0). For example, the first client device 130(0) may be assigned the domain name firstDevice.home.network where home.network is the root subdomain of the smart network 102. Each service 250 exposed by the first client device 130(0) may be assigned a domain name of the form _serviceID.firstDevice.home.network.

Once the registrar server 220 has assigned unique domain names to the first client device 130(0) and each of the services 250 exposed by the first client device 130(0), and if an A type resource record does not exist in database 224 for the first client device 130(0), the registrar server 220 makes a call to the DNS server 222 with an Insert( ) message. Alternatively, if an A type resource record already exists in database 224 for the first client device 130(0), then the registrar server 220 makes a call to the DNS server 222 with an Update( ) message (not shown). In response to receiving an Insert( ) or Update( ) message, the DNS server 222 generates or updates an A type resource record in database 224 that is associated with the first client device 130(0). The DNS server 222 may also create or update SRV type resource records in database 224 for each service 250 exposed by the first client device 130(0) and specified in the arguments passed to the registrar server 220 via the Register( ) message. The A type resource record relates the unique domain name assigned to the first client device 130(0) to the IP address assigned to the first client device 130(0). Similarly, the SRV type resource records relate the unique domain name s assigned to each service 250 exposed by the first client device 130(0) to the domain name assigned to the first client device 130(0) as well as a port on the client device associated with a particular instance of the service.

Registration of the second client device 130(1) as well as the services 250 exposed to the smart network 102 by the second client device 130(1) is performed in a similar fashion to that described above for registration of the first client device 130(0) and the services 250 exposed to the smart network 102 by the first client device 130(0).

Once the registrar server 220 has assigned unique domain names to each of the client devices 130 and the services 250, the registrar server 220 then transmits an Identify( ) message to each of the first client device 130(0) and the second client device 130(1). The Identify( ) message is also an XML message that includes information that specifies other devices and services available on the smart network 102 as well as the unique domain names and IDs assigned to the client device 130 and the services exposed by the client device 130. In one embodiment, the registrar service 220 sends a complete list of all devices and services on the smart network 102 to the client device 130. In alternative embodiments, registrar server 220 filters the list of devices 130 and services 250 to include only those devices 130 or services 250 that the client device 130 would like to consume. By performing the filtering at the smart network host device 120, the complexity of the client device 130 may be reduced.

If the first client device 130(0) has exposed a first service 250(0) that is compatible with a second service 250(1) hosted by the second client device 130(1), then the second service 250(1) may call the first service 250(0) directly using the unique domain name of the first service 250(0) to transmit an Action( ) message to the first service 250(0). For example, the second service 250(1) may implement a media player and the first service 250(0) may implement a digital video recorder (DVR). The second service 250(1) may request a list of all available programs stored on the DVR in order to generate a menu of available programs to display to a viewer in a user interface displayed on a display associated with the second client device 130(1). In order to request the list of available programs, the second service 250(1) may transmit a properly formatted XML document to the URL (domain name) assigned to the first service 250(0). The first service 250(0) would then receive the XML message, process the message, and return a second Action( ) message that included the requested list of available programs in the body of the XML document in the returned Action( ) message. The client devices 130 do not need to know the IP address or port assigned to the particular service associated with the unique domain name they address the Action( ) message to because the client devices 130 include a standard DNS client that queries (DNSQuery( ) message) the DNS server 222 for the IP address and port number. The DNS server 222 resolves the unique domain name for the service and returns (DNSAddress( ) message) the IP address for the service to the client device to complete the transmission of the Action( ) message.

In one embodiment, client devices 130 transmit all messages to the registrar server 220 that then forwards the message on to the recipient client device 130 or service 250. In some embodiments, the registrar server 220 may act as a proxy between two client devices 130 or services 250 that implement incompatible protocols, receiving a message formatted according to a first protocol, reformatting the message to match a second protocol compatible with the recipient client device 130 or service 250. In yet other embodiments, the registrar server 220 may act as a proxy for services located on the external network 110 making services outside of smart network 102 available to devices connected to smart network 102. In order to make such external services available to client devices 130 or services 250, the smart network host device 120 may be configured to query a well-known URL on the external network to receive a list of available services. Each of the available services may then be registered in the database 224 and associated with an IP address in the external network 110. Thus, client devices 130 may be shielded from any additional complexity with communicating with the external network, but still are exposed to services as if they were located on the smart network 102.

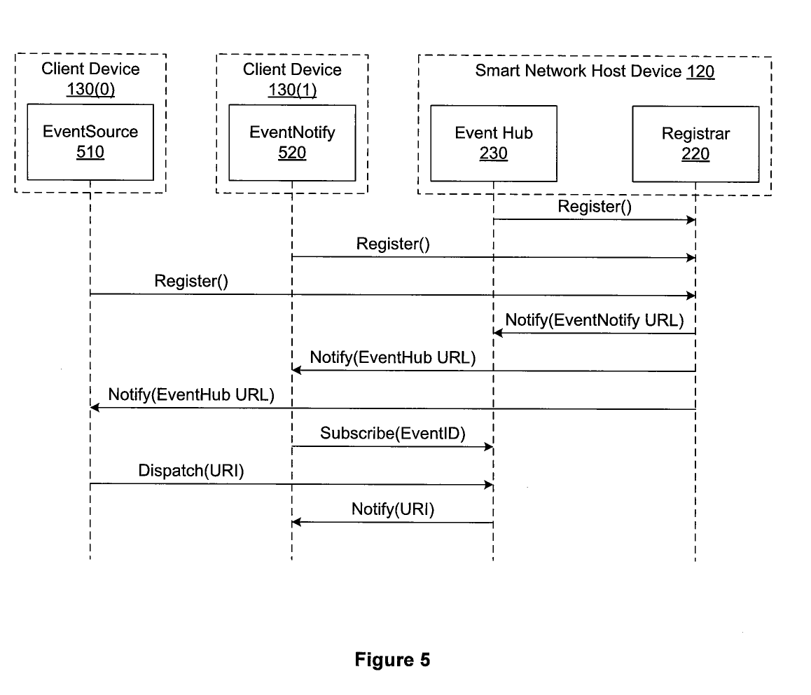

FIG. 5 is a conceptual diagram that illustrates a mechanism for exposing service events to services 250 on the smart network 102, according to one example embodiment of the present invention. As shown in FIG. 5, the smart network 102 includes a smart network host device 120 as well as a first client device 130(0) and a second client device 130(1). The smart network host device 120 includes a registrar server 220 and an event hub server 230. The smart network host device 120 and the client devices 130 are configured as described above in connection with FIGS. 1A-1F, 2 and 3.

In order to expose service events to various services 250 running on client devices 130 connected to the smart network 102, the smart network host device 120 may implement an event hub 230 configured to pass messages related to various events to an EventNotify client 520 included in each client device 130. Once the first client device 130(0) and the second client device 130(1) are connected to the smart network 102, the event hub server 230, the EventNotify client 520 and an EventSource service 510 may be registered with the registrar server 220 and each assigned a unique IP address and port number (the EventNotify client 520 and the EventSource service 510 are both services 250 as described above in connection with FIGS. 1A-1F and 2-4). Once one or more EventNotify clients 520 have registered with the registrar server 220, the registrar server 220 transmits a Notify( ) message to the event hub server 230 that specifies the domain name (URL) for each distinct EventNotify client 520 exposed on the smart network 102. The registrar server 220 also transmits a Notify( ) message to each client device 130 that specifies the domain name of the event hub server 230 running on the smart network host device 120. In alternative embodiments, only the event hub server 230 may transmit a Notify( ) message and, therefore, the registrar server 220 transmits the domain names for the EventNotify client 520 and event hub server 230 to the event hub server 230 to forward to each client device 130.

In order to receive notifications about a particular service event, a client device 130, via the registered EventNotify client 520, must subscribe to be notified by the event hub server 230 when particular types of events are generated by one or more services on the smart network 102. Thus, the EventNotify client 520 transmits a Subscribe( ) message to the event hub server 230 that includes one or more EventIDs that specify the types of service events that should result in a message being sent from the event hub server 230 to that EventNotify client 520. For example, a second service 250(1), running on the second client device 130(1), may subscribe to be notified whenever a media storage device stores media content to a memory (i.e., a media_recorded event). In order to subscribe to receive notifications about when these types of events occur, the EventNotify client 520 transmits a Subscribe( ) message to the event hub 230 that includes an EventID associated with that particular event type.

Similarly, when a first service 250(0) (i.e., EventSource service 510), hosted by the first client device 130(0), generates a service event, the first client device 130(0) transmits a Dispatch( ) message to the event hub server 230 that includes a uniform resource identifier (URI) associated with the event. The event hub server 230 then processes the event received via the Dispatch( ) message to determine the type of event associated with the included URI. If the type of event associated with the URI matches the type of event specified by the EventID included in the Subscribe( ) message sent by the EventNotify client 520, then the event hub server 230 transmits a Notify( ) message to the EventNotify client 520. The EventNotify client 520 processes the Notify( ) message and makes any information about the event available to one or more services 250 running on the second client device 130(1).

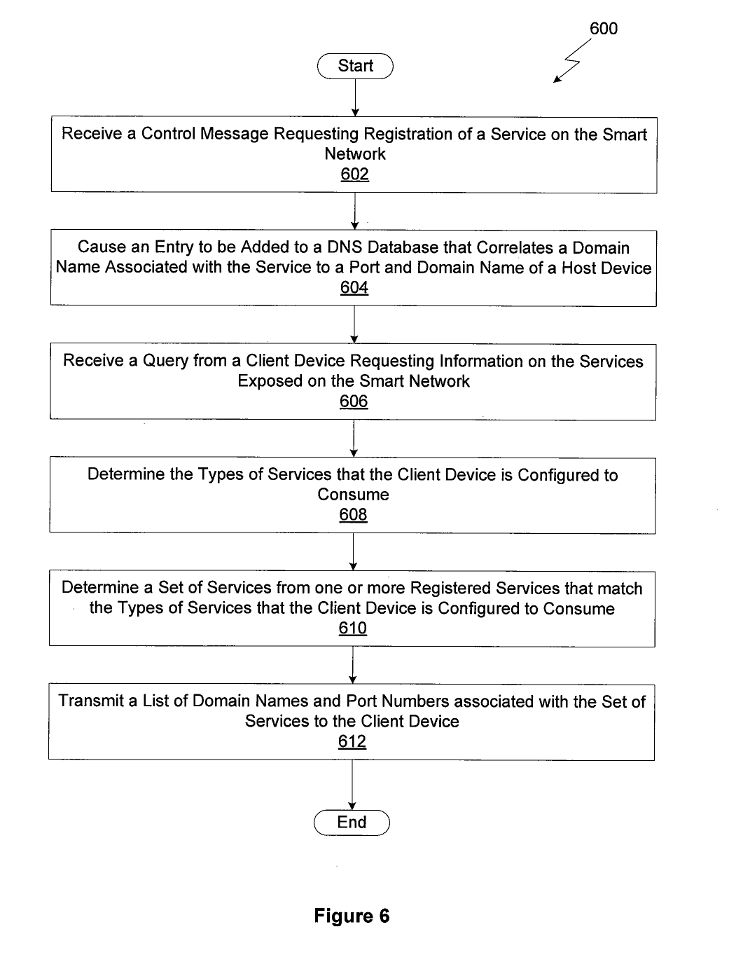

FIG. 6 is a flowchart of method steps 600 for registering services 250 with a smart network host device 120 and exposing available services 250 to a client device 130, according to one example embodiment of the present invention. Although the method steps are described in conjunction with the network system 100 of FIGS. 1A-1F and 2, persons skilled in the art will understand that any network system configured to perform the method steps, in any order, is within the scope of the invention.

As shown, the method 600 begins at step 602, where the smart network host device 120 receives a control message requesting registration of a service 250 on the smart network 102. In one embodiment, the control message is a call to a registrar server 220 that causes the registrar server 220 to assign a domain name to a client device 130 hosting one or more services 250. The control message may include information that specifies the IP address assigned to the client device 130 that hosts the services 250 as well as a port number assigned to each instance of a service 250 that is exposed on the client device 130. At step 604, the smart network host device 120 causes an entry to be added to a database that correlates a domain name associated with the particular instance of a service 250 to a port and a domain name for the host device. In one embodiment, the database is a DNS database and the entry is a SRV type resource record.

At step 606, the smart network host device 120 receives a query from a client device 130 that requests information on the services 250 exposed on the smart network 102. At step 608, the smart network host device 120 determines the types of services that the client device 130 is configured to consume. In one embodiment, the client device 130 transmits a list of the types of services the client device is configured to consume when the client device 130 registers with the smart network host device 120. At step 610, the smart network host device 120 determines a set of services 250 from the one or more services registered with the smart network host device 120. In one embodiment, the smart network host device 120 compares a list of the types of services 250 that the client device 130 is configured to consume to a service type field included in the SRV resource record associated with each service registered on the smart network 102. At step 612, the smart network host device 120 transmits a list of domain names and port numbers associated with the set of services 250 to the client device 130. The client device 130 may then make calls to one or more of the services 250 in the set of services by transmitting a message to the domain name and port number associated with that service

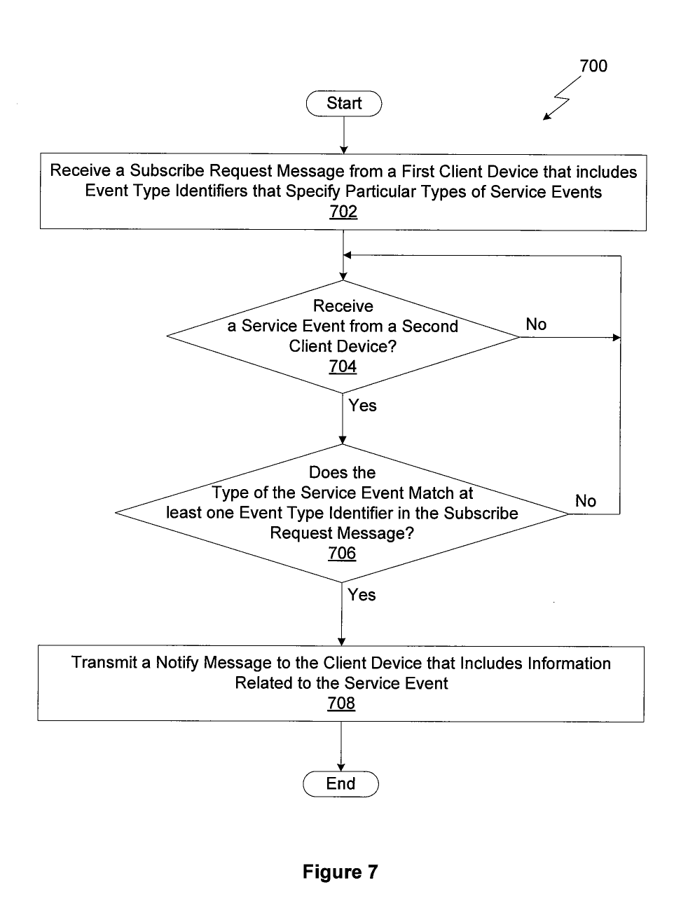

FIG. 7 is a flowchart of method steps 700 for registering services 250 with an event hub server 230 implemented by a smart network host device 120, according to one example embodiment of the present invention. Although the method steps are described in conjunction with the network system 100 of FIGS. 1A-1F and 2, persons skilled in the art will understand that any network system configured to perform the method steps, in any order, is within the scope of the invention.

As shown, the method 700 begins at step 702, where the event hub server 230 receives a subscribe request message from a first client device 130(0). In one embodiment, a client device 130 may implement a EventNotify client 520 that is configured to request that a particular service 250 receive messges that include information about service events on the smart network 102. The subscribe request message may include one or more EventIDs that specify the particular types of service events that the event hub server 230 should generate and transmit a message about the service event to the first client device 130(0). At step 704, the event hub server 230 determines whether a service event has been generated by a service 250 connected to the smart network 102. If a service event has not been generated, then the event hub server 230 waits until a service event is generated. However, if a service event has been generated, then method 700 proceeds to step 706 where the event hub server 230 determines whether the type of the service event matches at least one of the service event types specified by the EventIDs included in the subscribe request message from the first client device 130(0).

If the type of service event does not match one of the service event types specified by the EventIDs, then method 700 returns to step 704 where event hub server 230 waits for a new service event to be generated by a client device 130 connected to the smart network. However, if the type of service event matches one of the service event types specified by the EventIDs, then method 700 proceeds to step 708 where event hub server 230 transmits a notify message to the first client device that includes information related to the service event.

In sum, example embodiments of the invention provide systems and methods for discovering client devices and services connected to a smart network. A central authority of the smart network provisions and tracks the various devices connected to the smart network. Unique domain names are assigned to each client device or service and a central database relates the unique domain name to a location of the client device or service on the smart network. A client device may then query the central authority to determine what client devices and services are available to provide additional functionality or resources to the client device. The central authority may also enable different services that implement different protocols to communicate transparently by acting as a proxy server between the services. In addition, the central authority may make services located on an external network available to various client devices connected to the smart network.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to certain example embodiments of the present invention, other and further embodiments of the disclosure may be devised without departing from the basic scope thereof. Therefore, the scope of the present invention is determined by the claims that follow.

We claim:

1. A method, comprising:
receiving a first message requesting that a first client device be registered with a central authority associated with a local network, wherein the first client device is identified by a first internet protocol (IP) address and implements one or more services, and each instance of a particular service is accessible at a different port of a network interface associated with the first client device;
in response to the first message:
assigning a first domain name to the first client device and adding a first entry to a database that relates the first domain name to the first IP address, and
for each instance of the particular service implemented on the first client device, adding a corresponding entry in the database that relates the instance to one of the different ports as well as the first domain name; and
transmitting a response message to the first client device that indicates the first domain name assigned to the first client device.

2. The method of claim 1, further comprising:
receiving a second message requesting that a second client device be registered with the central authority, wherein the second client device is identified by a second IP address and implements one or more additional services, and each instance of a particular additional service is accessible at a different port of a network interface associated with the second client device;
in response to the second message:
assigning a second domain name to the second client device and adding a second entry to the database that relates the second domain name to the second IP address, and
for each instance of the particular additional service implemented on the second client device, adding a corresponding entry in the database that relates the instance to one of the different ports as well as the second domain name; and
transmitting a response message to the second client device that indicates the second domain name assigned to the second client device.

3. The method of claim 2, further comprising:
receiving a query from the second client device that requests information about the services that are available on the local network;
determining a set of services that are both compatible with the second client device and implemented by the first client device; and
transmitting a message to the second client device that indicates the port assigned to each instance of a service in the set of services as well as the first domain name.

4. The method of claim 2, further comprising:
adding a different entry to the database for each external service located on an external network, wherein each entry relates a domain name associated with a particular instance of an external service to a location of the particular service on the external network; and
transmitting a message to the first client device that indicates the location of each external service.

5. The method of claim 4, wherein the central authority is configured to act as a proxy for transmitting messages between two different services.

6. The method of claim 5, wherein the central authority receives a message formatted according to a first protocol underlying a first service implemented on the first client, reformats the message to make the message compatible with a second protocol underlying a second service implemented on the second client or a third protocol underlying a third service located on the external network, and transmitting the message to the second service or the third service, as the case may be.

7. The method of claim 1, further comprising:
receiving a subscribe request message from the first client device that includes one or more event type identifiers that specify a type of service event to associate with a particular service implemented on the first client device; and
in response to a first service event having a type that matches at least one of the one or more event type identifiers, transmitting a notify message to the first client device that includes information related to the first service event.

8. The method of claim 1, wherein each service is defined as a set of zero or more simple object access protocol (SOAP) actions and zero or more service events, and each message is formatted according to an extensible markup language (XML) protocol.

9. A system, comprising:
a first client device, wherein the first client device is identified by a first internet protocol (IP) address and implements one or more services, and each instance of a particular service is accessible at a different port of a network interface associated with the first client device; and
a smart network host device configured to:
receive a first message requesting that the first client device be registered with a central authority associated with a local network,
in response to the first message:
assign a first domain name to the first client device and add a first entry to a database that relates the first domain name to the first IP address, and
for each instance of the particular service implemented on the first client device, add a corresponding entry in the database that relates the instance to one of the different ports as well as the first domain name, and
transmit a response message to the first client device that indicates the first domain name assigned to the first client device.

10. The system of claim 9, further comprising a second client device, wherein the second client device is identified by a second IP address and implements one or more additional services, and each instance of a particular additional service is accessible at a different port of a network interface associated with the second client device, and wherein the smart network host device is further configured to:
receive a second message requesting that the second client device be registered with the central authority;
in response to the second message:
assign a second domain name to the second client device and add a second entry to the database that relates the second domain name to the second IP address, and
for each instance of the particular additional service implemented on the second client device, add a corresponding entry in the database that relates the instance to one of the different ports as well as the second domain name; and
transmit a response message to the second client device that indicates the second domain name assigned to the second client device.

11. The system of claim 10, the smart network host device is further configured to:
receive a query from the second client device that requests information about the services that are available on the local network;
determine a set of services that are both compatible with the second client device and implemented by the first client device; and
transmit a message to the second client device that indicates the port assigned to each instance of a service in the set of services as well as the first domain name.

12. The system of claim 10, the smart network host device is further configured to:
add a different entry to the database for each external service located on an external network, wherein each entry relates a domain name associated with a particular instance of an external service to a location of the particular service on the external network; and
transmit a message to the first client device that indicates the location of each external service.

13. The system of claim 12, wherein the smart network host device is configured to act as a proxy for transmitting messages between two different services.

14. The system of claim 13, wherein the smart network host device is further configured to receive a message formatted according to a first protocol underlying a first service implemented on the first client, reformat the message to make the message compatible with a second protocol underlying a second service implemented on the second client or a third protocol underlying a third service located on the external network, and transmit the message to the second service or the third service, as the case may be.

15. The system of claim 9, the smart network host device being further configured to:
receive a subscribe request message from the first client device that includes one or more event type identifiers that specify a type of service event to associate with a particular service implemented on the first client device; and
in response to a first service event having a type that matches at least one of the one or more event type identifiers, transmitting a message to the first client device that includes information related to the first service event.

16. The system of claim 9, wherein each service is defined as a set of zero or more simple object access protocol (SOAP) actions and zero or more service events, and each message is formatted according to an extensible markup language (XML) protocol.

17. A computer-readable medium including instructions that, when executed by a processing unit, cause the processing unit to perform the steps of:
receiving a first message requesting that a first client device be registered with a central authority associated with a local network, wherein the first client device is identified by a first internet protocol (IP) address and implements one or more services, and each instance of a particular service is accessible at a different port of a network interface associated with the first client device;
in response to the first message:
assigning a first domain name to the first client device and adding a first entry to a database that relates the first domain name to the first IP address, and
for each instance of the particular service implemented on the first client device, adding a corresponding entry in the database that relates the instance to one of the different ports as well as the first domain name; and
transmitting a response message to the first client device that indicates the first domain name assigned to the first client device.

18. The computer-readable medium of claim 17, the steps further comprising:
receiving a second message requesting that a second client device be registered with the central authority, wherein the second client device is identified by a second IP address and implements one or more additional services, and each instance of a particular additional service is accessible at a different port of a network interface associated with the second client device;
in response to the second message:
assigning a second domain name to the second client device and adding a second entry to the database that relates the second domain name to the second IP address, and
for each instance of the particular additional service implemented on the second client device, adding a corresponding entry in the database that relates the instance to one of the different ports as well as the second domain name; and
transmitting a response message to the second client device that indicates the second domain name assigned to the second client device.

19. The computer-readable medium of claim 18, the steps further comprising:
receiving a query from the second client device that requests information about the services that are available on the local network;
determining a set of services that are both compatible with the second client device and implemented by the first client device; and
transmitting a message to the second client device that indicates the port assigned to each instance of a service in the set of services as well as the first domain name.

20. The computer-readable medium of claim 18, the steps further comprising:
adding a different entry to the database for each external service located on an external network, wherein each entry relates a domain name associated with a particular instance of an external service to a location of the particular service on the external network; and
transmitting a message to the first client device that indicates the location of each external service.
